(19) United States
(12) Patent Application Publication
(10) Pub. No.: US 2015/0328924 A1
(43) Pub. Date: Nov. 19, 2015

(54) TIRE SHIELD MOUNTING SYSTEM

(71) Applicant: Hutchinson S.A., Paris (FR)

(72) Inventor: Christopher R. Renson, Langhorne, PA (US)

(21) Appl. No.: 14/711,301

(22) Filed: May 13, 2015

Related U.S. Application Data
(60) Provisional application No. 61/992,475, filed on May 13, 2014.

(51) Int. Cl. B60B 7/01; B60B 7/14; B60B 7/04

(52) U.S. Cl. CPC B60B 7/01; B60B 7/04; B60B 7/14; B60B 2900/212

(57) ABSTRACT

A system. The system includes a wheel, a mounting system and a protective member. The mounting system is connected to the wheel and includes a mounting adapter, a tension assembly and a standoff assembly. The tension assembly is connected to the wheel and the mounting adapter. The standoff assembly is connected to the mounting adapter and is in contact with the wheel. The protective member is connected to the mounting adapter.

### CROSS-REFERENCE TO RELATED APPLICATION

This application claims the benefit under 35 U.S.C. §119(e) of the earlier filing date of U.S. Provisional Patent Application No. 61/992,475 filed on May 13, 2014, the content of which is hereby incorporated by reference in its entirety.

### BACKGROUND

This application discloses an invention which is related, generally and in various embodiments, to a system for mounting a protective member (e.g., a tire shield or a wheel protector) to a wheel.

There are many known ways to attach a tire shield and/or a wheel cover to a wheel. For example, in some instances, a tire shield is attached directly to a wheel utilizing a plurality of fasteners which are screwed into threaded receptacles positioned around an outer face of the wheel.

A tire shield and/or a wheel cover attached to a wheel can be subjected to both radial loads and lateral or axial loads. Unfortunately, in many instances, the lateral or axial loads are transferred from the tire shield and/or wheel cover to an outer flange of the wheel, and the transferred lateral or axial loads can potentially cause undesirable damage to the flange of the wheel. In cases where the wheel includes a removable flange portion, the transferred lateral or axial loads can push the removable part of the flange inboard which in turn can compromise the pressure seal between the wheel and a tire mounted thereon.

### BRIEF DESCRIPTION OF THE DRAWINGS

Various embodiments of the invention are described herein in by way of example in conjunction with the following figures, wherein like reference characters designate the same or similar elements.

FIG. 1 illustrates an exploded view of a tire shield mounting system according to various embodiments;

FIG. 2 illustrates a perspective view the tire shield mounting system of FIG. 1 connected to a wheel;

FIG. 3 illustrates another perspective view of the tire shield mounting system of FIG. 1 connected to a wheel;

FIG. 4 illustrates other embodiments of a tire shield mounting system;

FIG. 5 illustrates yet other embodiments of a tire shield mounting system; and

FIG. 6 illustrates yet other embodiments of a tire shield mounting system.

### DETAILED DESCRIPTION

In the following detailed description, reference is made to the accompanying drawings, which form a part hereof. In the drawings, similar symbols and reference characters typically identify similar components throughout the several views, unless context dictates otherwise. The illustrative embodiments described in the detailed description, drawings, and claims are not meant to be limiting. Other embodiments may be utilized, and other changes may be made, without departing from the scope of the subject matter presented here.

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Before explaining the various embodiments of the mounting system in detail, it should be noted that the various embodiments disclosed herein are not limited in their application or use to the details of construction and arrangement of parts illustrated in the accompanying drawings and description. Rather, the disclosed embodiments may be positioned or incorporated in other embodiments, variations and modifications thereof, and may be practiced or carried out in various ways. Accordingly, embodiments of the mounting system disclosed herein are illustrative in nature and are not meant to limit the scope or application thereof. Furthermore, unless otherwise indicated, the terms and expressions employed herein have been chosen for the purpose of describing the embodiments for the convenience of the reader and are not to limit the scope thereof. In addition, it should be understood that any one or more of the disclosed embodiments, expressions of embodiments, and/or examples thereof, can be combined with any one or more of the other disclosed embodiments, expressions of embodiments, and/or examples thereof, without limitation.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

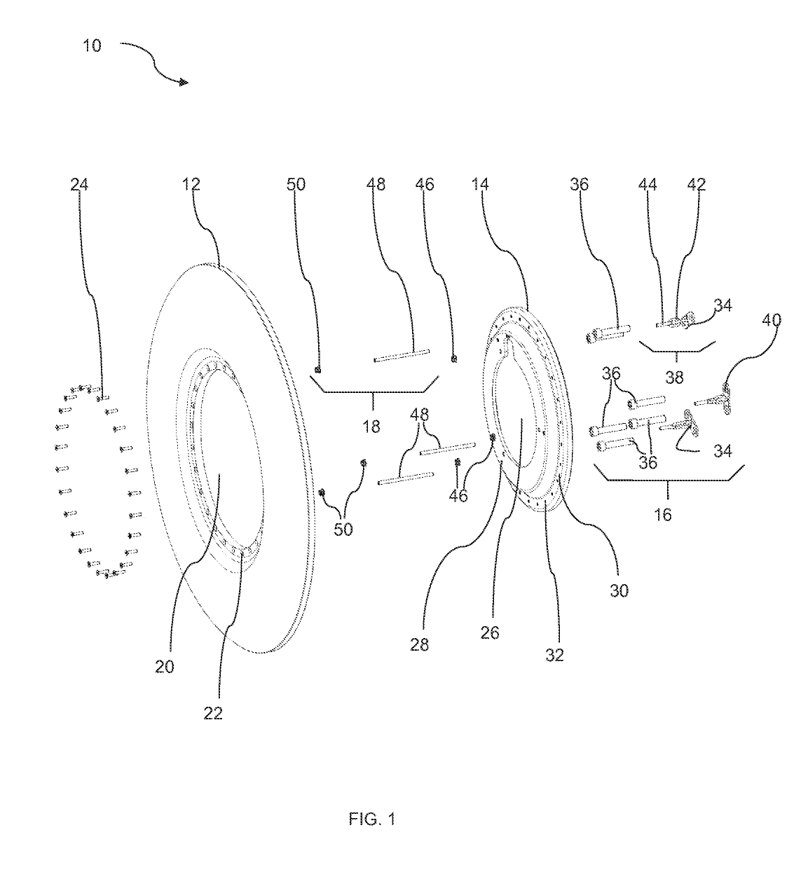

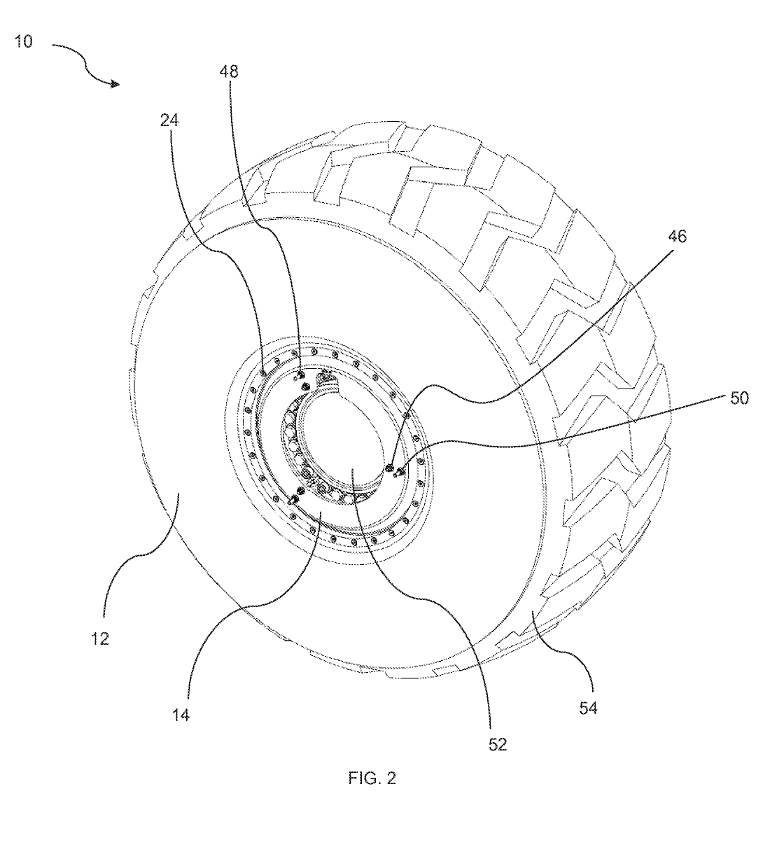

FIG. 1 illustrates an exploded view of a mounting system 10 according to various embodiments. The system 10 can be utilized to mount a protective member 12 (or protective members) such as a tire shield 12 and/or a wheel cover (not shown) to a wheel. The system 10 includes a mounting adapter 14, a tension assembly 16 and a standoff assembly 18. For purposes of simplicity, neither a wheel nor a tire are shown in FIG. 1 (See, e.g. FIG. 2). Additionally, although the system 10 will be described hereinafter in the context of a tire shield mounting system, it will be appreciated that the system 10 can also be utilized to mount a wheel cover or the like to a wheel. In various embodiments, the mounting system 10 can be utilized to mount both a tire shield 12 and a wheel cover to a wheel. However, for purposes of simplicity, the system 10 will be described hereinafter in the context of a tire shield mounting system.

The tire shield 12 can be any suitable type of tire shield which is utilized to protect a sidewall of a tire mounted on a wheel. For the embodiments shown in FIG. 1, the tire shield 12 defines a central opening 20 and also defines a plurality of openings 22 proximate and surrounding the central opening 20. The respective openings 22 are sized to allow for a fastener 24 (e.g., a threaded fastener such as a screw) to pass therethrough. As described in more detail hereinbelow, the fasteners 24 are utilized to fasten the tire shield 12 to the mounting adapter 14.

According to various embodiments, the mounting adapter 14 is also ring-shaped, defines a central opening 26 and also defines a plurality of openings 28 proximate and surrounding the central opening 26. For each pair of respective openings 28, one of the openings 28 is sized to allow for a portion of the tension assembly 16 to pass therethrough and the other of the openings 28 is sized to allow for a portion of the standoff assembly 18 to pass therethrough. As described in more detail hereinbelow, the portion of the tension assembly 16 and the portion of the standoff assembly 18 which passes through the openings 28 may be embodied as a threaded rod. Although three pairs of openings 28 are shown in FIG. 1, spaced approximately 120° apart from one another, it will be appreciated that the adapter 14 may define more or less openings 28 than are shown in FIG. 1.

For the embodiments shown in FIG. 1, the mounting adapter 14 also includes a flange portion 30 which defines a plurality of openings 32. The respective openings 32 correspond to the openings 22 of the tire shield 12 and are sized to receive the fasteners 24. When the fasteners 24 are passed through the openings 22 of the tire shield 12 and are received by the openings 32 of the mounting adapter 14, the tire shield 12 becomes connected to the mounting adapter 14.

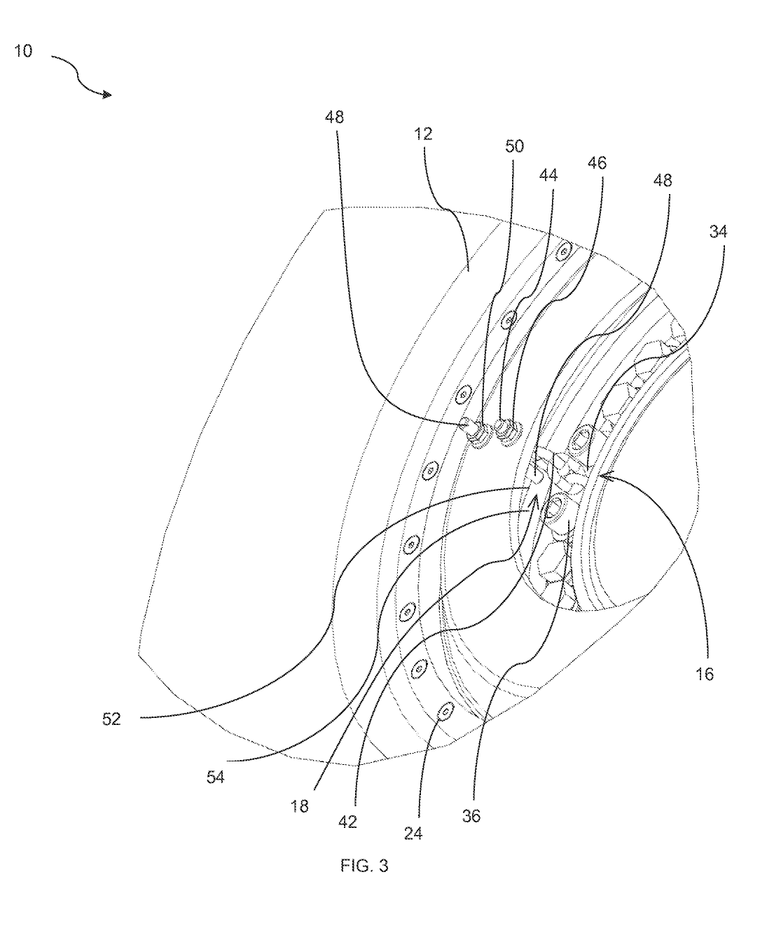

The tension assembly 16 includes an anchor plate 34, lug bolts 36 and an adjustable length chain assembly 38. The components of the tension assembly 16 are also shown in FIG. 3. The anchor plate 34 defines two openings 40 which are each sized to receive a lug bolt 36. To accommodate the thickness of the anchor plate 34, the lug bolts 36 have a length which is longer than the lug bolts of the wheel. When the lug bolts 36 are passed through the openings 40 and are connected to the wheel, the anchor plate 34 also becomes connected to the wheel. The adjustable length chain assembly 38 is connected to the anchor plate 34. The adjustable length chain assembly 38 includes one or more chain links 42, a threaded rod 44 and a nut 46. One of the chain links 42 is connected to the anchor plate 34. The threaded rod 44 is connected to another one of the chain links 42 (or to the same chain link 42 that is connected to the anchor plate 34) and passes through an opening 28. The nut 46 is threaded onto an end of the threaded rod 44 at the outer face of the mounting adapter 14 and is utilized to adjust the tensioning force associated with the tension assembly 16. Once installed, the tension assembly 16 operates to prevent the mounting adapter 14, and by extension the tire shield 12 connected to the mounting adapter 14, from pulling away from the wheel.

The standoff assembly 18 includes a threaded rod 48 and a nut 50. The threaded rod 48 passes through an opening 28 and is placed in contact with a non-flange portion of the wheel. The nut 50 is threaded onto an end of the threaded rod 48 at the outer face of the mounting adapter 14. Once installed, the standoff assembly 18 operates to keep the mounting adapter 14, and by extension the tire shield 12 connected to the mounting adapter 14, a set distance from the wheel. The standoff assembly 18 also operates to prevent lateral or axial loads from loading the outer flange of the wheel. Instead, the standoff assembly 18 operates to transfer lateral or axial loads to the non-flange portion of the wheel.

FIG. 2 illustrates a perspective view of the tire shield mounting system 10 connected to a wheel 52 having a tire 54 mounted thereon. In the perspective view of FIG. 2, the tire shield 12 is connected to the mounting adapter 14 and is positioned to protect a sidewall of the tire 54, and the portions of the tension assembly 16 (e.g., nut 46) and the standoff assembly 18 (e.g., nut 50) located axially outward from the mounting adapter 14 are visible. Although the system 10 may be utilized to connect a tire shield 12 to any type of wheel, as explained in more detail hereinbelow, the system 10 is particularly useful for connecting a tire shield 12 to a wheel 52 of a piece of heavy equipment (i.e., a heavy machine) such as those used in heavy industrial and/or mining operations.

FIG. 3 illustrates another perspective view of the tire shield mounting system 10 connected to a wheel 52 having a tire 54 mounted thereon. For purposes of simplicity, the tire 54 is not shown in FIG. 3 and only a portion of the tire shield mounting system 10 is shown in FIG. 3. In the perspective view of FIG. 3, the tension assembly 16 (e.g., anchor plate 34, lug bolts 36, chain links 42, threaded rod 44 and nut 46) is shown being connected to both the mounting adapter 14 and the wheel 52 (the anchor plate 34 is connected to the wheel 52, and the adjustable length chain assembly 38 is connected to the mounting adapter 14). Additionally, the standoff assembly 18 (e.g., threaded rod 48 and nut 50) is shown being connected to the mounting adapter 14 and in contact with the wheel 52 (the threaded rod 48 and nut 50 are connected to the mounting adapter 14 and the threaded rod 48 is also in contact with a non-flange portion of the wheel 50).

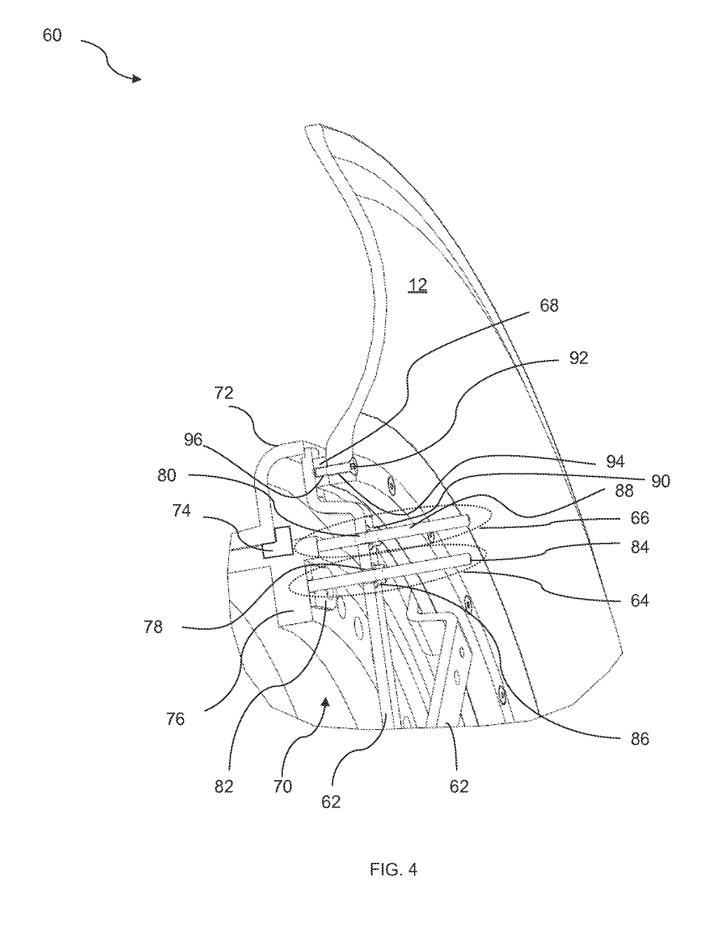

FIG. 4 illustrates other embodiments of a tire shield mounting system 60. The system 60 is similar to the system 10 in that it includes a mounting adapter 62, a tension assembly 64 and a standoff assembly 66, but is different in that the mounting adapter 62 is somewhat different than the mounting adapter 14, and the tension assembly 64 is somewhat different than the tension assembly 16. The system 60 is also different in that it includes a spacer member 68 positioned between the tire shield 12 and the mounting adapter 62.

As shown in FIG. 4, the wheel 70 includes a removeable flange portion 72, a removeable lock ring 74 and a non-flange portion 76. This type of wheel 70, which is commonly used on heavy equipment, is also known as a demountable rim. The removeable lock ring 74 operates to keep the removeable flange portion 72 in place once a tire mounted to the wheel 70 is inflated. For purposes of simplicity, the tire is not shown in FIG. 4.

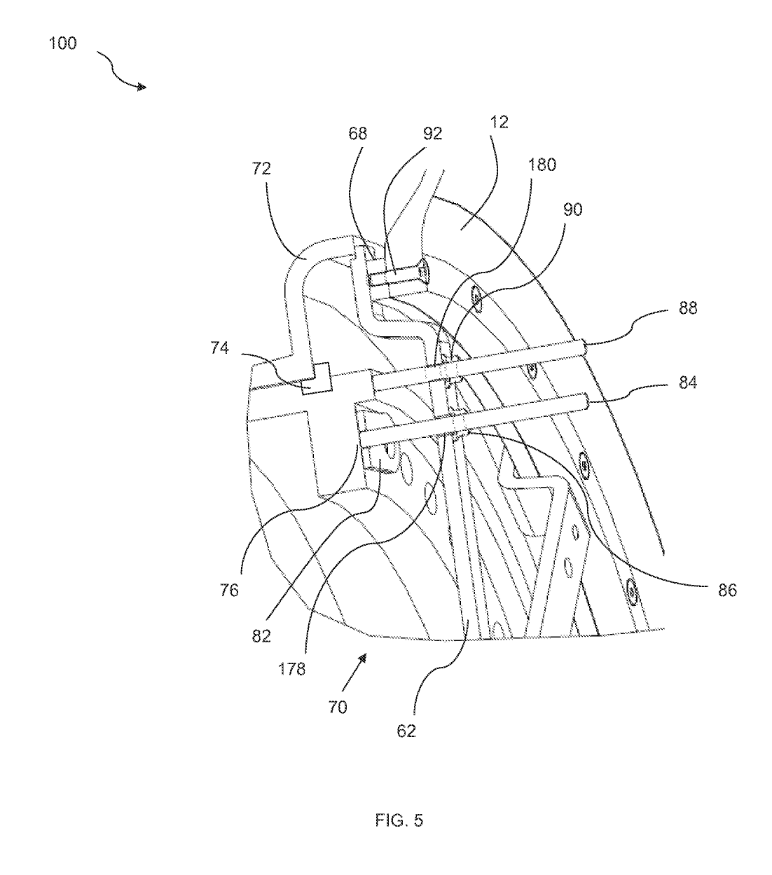

For the embodiments shown in FIG. 4, the mounting adapter 62 includes three spokes which are connected to one another proximate a center of the wheel 70 and are spaced approximately 120° from one another at the radial outermost ends of the spokes. Of course, according to other embodiments, the mounting adapter 62 may include fewer than three spokes (e.g., two spokes) or more than three spokes (e.g., four spokes). For purposes of simplicity, only a portion of one of the spokes of the mounting adapter 62 is shown in FIG. 4. Each spoke defines two openings 78, 80. Opening 78 is sized to receive a portion of the tension assembly 64 and opening 80 is sized to receive a portion of the standoff assembly 66. At least one of the openings 78, 80 may be threaded (See FIG. 5) or non-threaded openings. According to various embodiments, the spokes of the mounting adapter 62 are configured to register against the removeable flange portion 72 of the wheel 70 and operate to transfer radial and/or lateral loads applied to the mounting adapter 62 (and/or the tire shield 12) to the removeable flange portion 72 of the wheel 70, and in turn to the non-flange portion 76 of the wheel 70.

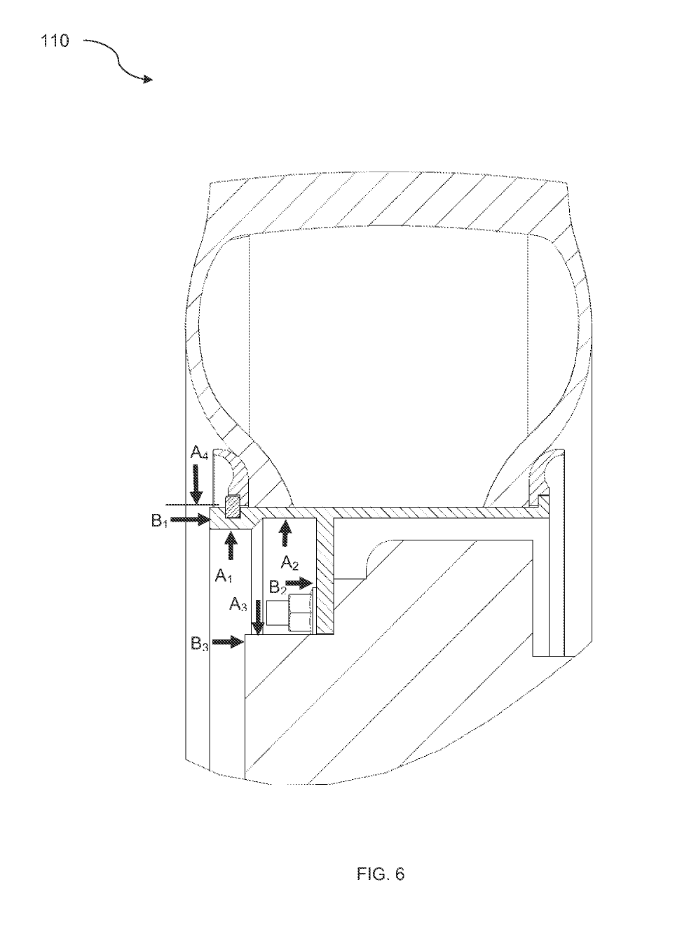

Although not shown in FIG. 4 for purposes of simplicity, it will be appreciated that the wheel 70 may be mounted to a vehicle hub (See FIG. 6). According to various embodiments, the spokes of the mounting adapter 62 may also operate to transfer radial and/or lateral loads applied to the mounting adapter 62 (and/or the tire shield 12) to the vehicle hub.

As shown in FIG. 4, the tension assembly 64 includes an anchor plate 82, a threaded rod 84 and a nut 86. The anchor plate 82 is connected to the wheel 70 and may be connected to the wheel 70 in any suitable manner. For example, according to various embodiments, the anchor plate 82 is connected to the wheel 70 by lug bolts similar to lug bolts 36. The threaded rod 84 is connected to the anchor plate 82 and may be connected to the anchor plate 82 in any suitable manner. For example, according to various embodiments, an end of the threaded rod 84 is welded to or otherwise integrated with the anchor plate 82. According to other embodiments, the anchor plate 82 defines a threaded receptacle, and the threaded rod 84 is threaded into the threaded receptacle. The threaded rod 84 passes through the opening 78 and is threadedly engaged with the nut 86. For embodiments where the opening 78 is a threaded opening, the nut 86 may be eliminated according to various embodiments.

The standoff assembly 66 includes a threaded rod 88 which is in contact with the non-flange portion 76 of the wheel 70, passes through the opening 80 and is threadedly engaged with a nut 90. For embodiments where the opening 80 is a threaded opening, the nut 90 may be eliminated according to various embodiments.

The spacer member 68 is positioned between the tire shield 12 and the mounting adapter 62, and may be connected to the tire shield 12 and/or the mounting adapter 62 in any suitable manner. For example, as shown in FIG. 4, the spacer member 68 is connected to the tire shield 12 via a plurality of fasteners 92 which pass through openings 94 in the tire shield 12 and are threadedly connected to threaded receptacles 96 defined by the spacer member 68. According to various embodiments, the spacer member 68 may be connected to the mounting adapter 62 via fasteners similar to fasteners 92. For such embodiments, which are not shown for purposes of simplicity, each spoke of the mounting adapter 62 may define a threaded receptacle, and fasteners longer than fasteners 92 may pass through openings 94 in the tire shield 12, through threaded or non-threaded openings in the spacer member 68, and be threadedly connected to the threaded receptacles defined by the spokes of the mounting adapter 62. According to various embodiments, the spacer member 68 is ring-shaped. According to other embodiments, a plurality of the spacer members 68 may be utilized in lieu of a ring-shaped spacer member 68.

FIG. 5 illustrates yet other embodiments of a tire shield mounting system 100. The system 100 is similar to the system 60, but is different. In lieu of the openings 78, 80, the system 100 includes openings 178, 180 wherein at least one of the openings 178, 180 is a threaded opening. For embodiments where the opening 180 is a threaded opening, the axial position of the mounting adapter 62 relative to the wheel 70 can be set by rotating the threaded rod 88. Once the axial position of the mounting adapter 62 is set at the desired location, the nut 90 can be utilized to fix the mounting adapter 62 at the desired location. Similarly, for embodiments where the opening 178 is a threaded opening, the threaded rod 84 can be rotated to adjust the desired tension between the mounting adapter 62 and the wheel 70. Once the desired tension between the mounting adapter 62 and the wheel 70 is set, the nut 86 can utilized to secure the mounting adapter 62 to the wheel 70.

FIG. 6 illustrates yet other embodiments of a tire shield mounting system 110. The system 110 is similar to the system 10 (or the system 60), but is different in that (1) the positioning of the mounting adapter (e.g., mounting adapter 14 or mounting adapter 62) against the wheel and/or (2) the positioning of the threaded rod (e.g., threaded rod 48 or threaded rod 88) of the standoff assembly (e.g., standoff assembly 18 or standoff assembly 66) are not limited to the locations described hereinabove with respect to the embodiments shown in FIGS. 1-5.

For example, with respect to radial piloting of the mounting adapter against the wheel, in lieu of the mounting adapter being radially piloted against the “tip” of the removeable flange portion of the wheel as shown in FIGS. 4 and 5, the mounting adapter may be radially piloted against any other number of concentric features on the wheel. Several exemplary locations of such concentric features are labeled as A₁, A₂, A₃ and A₄ in FIG. 6, where A₁ is an inside diameter of the non-flange portion 76 of the wheel under the rim base lock-ring gutter, A₂ is an inside diameter of the non-flange portion 76 of the wheel at a flat base portion, A₃ is at an outside diameter of a vehicle hub and A₄ is at an outside diameter of the non-flange portion 76 of the wheel at a protruding ledge thereof. Of course, according to various embodiments, the mounting adapter may be radially piloted against the wheel at locations other than those labeled A₁-A₄ in FIG. 6.

With respect to axial positioning on the mounting adapter relative to the wheel, the threaded rod of the standoff assembly may be axially piloted against the non-flange portion 76 of the wheel as shown in FIGS. 4 and 5 (labeled B₁ in FIG. 6), or may be axially piloted against any number of different secure vertical surfaces of the wheel and/or vehicle hub. Several exemplary locations of such secure vertical surfaces are labeled as B₁, B₂ and B₃ in FIG. 6, where B₁ is a secure vertical surface of the non-flange portion 76 of the wheel, B₂ is a secure vertical surface of the mounting disk of the wheel and B₃ is a secure vertical surface on the axially outermost surface of the vehicle hub. Of course, according to various embodiments, the mounting adapter may be axially piloted against the wheel or vehicle hub at locations other than those labeled B₁-B₃ in FIG. 6.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. For example, although the above-described embodiments show two different ways of connecting a mounting adapter (e.g., mounting adapter 14 or mounting adapter 62) to a wheel, it will be appreciated that the mounting adapter may be connected to a wheel (or a vehicle hub) in any number of different ways. Similarly, although the above-described embodiments show two different configurations for the tension assembly (tension assembly 16 and tension assembly 64), it will be appreciated that the functionality of the tension assembly can be realized in any number of different ways. For example, according to other embodiments, the tension assembly may utilize a flexible connection with cables in lieu of chain links. Also, the tension assembly can include more rigid components that may or may not flex at the point where the tension assembly attaches to the mounting adapter or to the anchor plate. For some embodiments, the connection between the mounting adapter and the wheel can be a part of the mounting adapter. Furthermore, although the above-described embodiments show the standoff assembly as being adjustable (to allow for manufacturing variation in wheel geometry), it will be appreciated that according to other embodiments the standoff assembly can be a fixed geometry which creates the desired axial positioning based on a designed clearance to the tip of the removable flange portion 72 of the wheel 70.

Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

What is claimed is:

1. A system, comprising:
a wheel;
a mounting system connected to the wheel, wherein the mounting system comprises:
a mounting adapter;
a tension assembly connected to the wheel and the mounting adapter; and
a standoff assembly connected to the mounting adapter and in contact with the wheel; and
a protective member connected to the mounting adapter.

2. The system of claim 1, wherein the wheel comprises:
a removable flange portion;
a non-flange portion; and
a lock ring intermediate the removable flange portion and the non-flange portion.

3. The system of claim 1, wherein the mounting adapter is configured to transfer at least one of the following to the wheel:
a radial load applied to the protective member;
a radial load applied to the mounting adapter;
a lateral load applied to the protective member; and
a lateral load applied to the mounting adapter.

4. The system of claim 3, wherein the mounting adapter is configured to transfer at least one of the following to a non-flange portion of the wheel:
a radial load applied to the protective member;
a radial load applied to the mounting adapter;
a lateral load applied to the protective member; and
a lateral load applied to the mounting adapter.

5. The system of claim 1, wherein the wheel is mounted to a vehicle hub and the mounting adapter is configured to transfer at least one of the following to the vehicle hub:
a radial load applied to the protective member;
a radial load applied to the mounting adapter;
a lateral load applied to the protective member; and
a lateral load applied to the mounting adapter.

6. The system of claim 1, wherein the tension assembly comprises:
a mounting plate connected to the wheel; and
an adjustable length chain assembly connected to the mounting plate and the protective member.

7. The system of claim 6, wherein the tension assembly comprises:
at least one chain link connected to the mounting plate;
a threaded rod connected to the at least one chain link; and
a nut connected to the threaded rod.

8. The system of claim 1, wherein the tension assembly comprises:
a threaded rod connected to the mounting plate; and
a nut connected to the threaded rod.

9. The system of claim 1, wherein the standoff assembly comprises:
a threaded rod in contact with a non-flange portion of the wheel; and
a nut connected to the threaded rod.

10. The system of claim 1, wherein the wheel is mounted to a vehicle hub and the standoff assembly comprises:
a threaded rod in contact with the vehicle hub; and
a nut connected to the threaded rod.

11. The system of claim 1, wherein the protective member comprises at least one of the following:
a tire shield; and
a wheel cover.

12. The system of claim 1, further comprising a spacer member positioned between the protective member and the mounting adapter.

13. A system for mounting a protective member to a wheel, the system comprising:
an adapter, wherein the adapter defines a first aperture and a second aperture radially offset from the first aperture;
a tension assembly positioned intermediate the adapter and the wheel, wherein the tension assembly comprises a first threaded rod positioned through the first aperture; and
a standoff assembly intermediate the adapter and the wheel, wherein the standoff assembly comprises a second threaded rod positioned through the second aperture.

14. The system of claim 13, wherein at least one of the first aperture and the second aperture comprises a threaded aperture.

15. The system of claim 13, wherein the tension assembly further comprises:
an anchor; and
a chain comprising at least one link, wherein the chain extends between the anchor and the first threaded rod.

16. The system of claim 15, wherein the chain comprises an adjustable length chain.

17. The system of claim 13, wherein the protective member comprises at least one of the following:
a tire shield; and
a wheel cover.

18. A system, comprising:
a wheel, comprising:
a base; and
a flange removably mounted to the base;
a protective member; and
a mounting system positioned intermediate the wheel and the protective member, wherein the mounting system comprises:
a mounting adapter fastened to the protective member; and
a standoff assembly fastened to the mounting adapter, wherein the standoff assembly abuts the base of the wheel.

19. The system of claim 18, wherein the protective member comprises at least one of the following:
a tire shield; and
a wheel cover.

20. The system of claim 18, wherein the mounting system further comprises a tension assembly fastened to the mounting adapter and extending from the base of the wheel.
